(19) United States
(12) Patent Application Publication
(10) Pub. No.: US 2015/0053705 A1
(43) Pub. Date: Feb. 26, 2015

(54) BUCKET HANDLE ADD-ON

(71) Applicant: D. WILSON INNOVATIONS INC., Calgary (CA)

(72) Inventors: DEVON WILSON, Calgary (CA); DALE R. MARSHALL, Calgary (CA); IMRE ORDOG, Calgary (CA)

(21) Appl. No.: 14/464,414

(22) Filed: Aug. 20, 2014

Related U.S. Application Data
(60) Provisional application No. 61/869,183, filed on Aug. 23, 2013.

(51) Int. Cl. B65D 25/32; A47J 47/18

(52) U.S. Cl. CPC B65D 25/32; A47J 47/18
USPC 220/755; 29/428

(57) ABSTRACT

A handle add-on for buckets and a method for installing same are provided. The handle add-on has a first portion and a second portion, both having a generally horizontal cylindrical segment shape. The first and second portions can be coupled and interlocked together to form a curved bore therebetween to accommodate a portion of a bucket handle by a method comprising: placing a portion of the handle into an axial channel of the second portion, positioning the first portion over the second portion, and interlocking the first and second portions by sliding the first portion axially relative to the second portion.

### FIELD OF THE INVENTION

The present invention relates to a handle add-on for buckets.

### BACKGROUND OF THE INVENTION

A conventional bucket (sometimes also referred to herein as “pail”) usually has a pivotable arched handle (sometimes also referred to herein as “bail”) that is usually made of hard plastic or metal. The handle is usually thin (i.e. small in diameter) so that it might place a lot of stress on the hand of the bucket carrier if there is a heavy load in the bucket.

### SUMMARY OF THE INVENTION

In accordance with a broad aspect of the present invention, there is provided a handle add-on for attachment to a bucket handle comprising: a first portion having (i) an elongated body with a first end, a second end, two lengthwise sides, an outer surface and a base connecting the lengthwise sides, (ii) an axially extending channel in the elongated body that opens outwardly away from the base and opens at the first end and the second end, the channel having two lengthwise sides, (iii) at least one leg at or near each lengthwise side of the channel, the at least one leg extending in a direction from the outer surface to the base and having at least one foot extending laterally from a free end thereof, and (iv) a notch adjacent to the foot; and a second portion having (i) an elongated body with a first end, a second end, two lengthwise sides, an outer surface and a base connecting the lengthwise sides, (ii) an axially extending ridge in the elongate body, the ridge having formed therein an axially extending convexly arched channel that opens outwardly away from the base and opens at the first end and the second end, (iii) at least one flange at or near each lengthwise side, extending laterally in a direction from the outer surface towards the arched channel, the at least one flange providing an inner shoulder thereunder for receiving and matingly engaging at least a portion of the at least one foot, and (iv) a notch adjacent to the flange for receiving the at least one foot therethrough, the notch of the first portion for receiving the at least one flange therethrough, the handle add-on having an open position, wherein the bases of the first and second portions are substantially parallel and in contact with one another, the at least one foot is received in the notch of the second portion, the at least one flange is received in the notch of the first portion, the channels of the first and second portions are substantially aligned, and the first portion and second portion are separable from one another; and a closed position, wherein the bases of the first and second portions are substantially parallel and in contact with one another, at least a portion of the at least one foot is received in the inner shoulder of the at least one flange, thereby interlocking connecting the first and second portions, and the channels of the first and second portions defining an axial bore.

In accordance with another broad aspect of the present invention, there is provided a method of installing a handle add-on on to a bucket handle comprising: placing an underside of a portion of the bucket handle in a channel of a second portion of the handle add-on, the handle add-on comprising a first portion having (i) an elongated body with a first end, a second end, two lengthwise sides, an outer surface and a base connecting the lengthwise sides, (ii) an axially extending channel in the elongated body that opens outwardly away from the base and opens at the first end and the second end, the channel having two lengthwise sides, (iii) at least one leg at or near each lengthwise side of the channel, the at least one leg extending in a direction from the outer surface to the base and having at least one foot extending laterally from a free end thereof, and (iv) a notch adjacent to the foot; and the second portion having (i) an elongated body with a first end, a second end, two lengthwise sides, an outer surface and a base connecting the lengthwise sides, (ii) an axially extending ridge in the elongate body, and the channel being formed in the ridge, the channel being convexly arched and axially extending in the ridge, and the channel opens outwardly away from the base and opens at the first end and the second end, (iii) at least one flange at or near each lengthwise side, extending laterally in a direction from the outer surface towards the arched channel, the at least one flange being receiving in the notch of the first portion and providing an inner shoulder thereunder for receiving and =tingly engaging at least a portion of the at least one foot, and (iv) a notch adjacent to the flange for receiving the at least one foot therethrough; positioning the first portion over the second portion to place the bases of the first and second portions substantially parallel and in contact with one another, the at least one foot in the notch of the second portion, and the at least one flange in the notch of the first portion, to align the channels of the first and second portions whereby most of the portion of the bucket handle is covered by the channel of the first portion; and sliding the first portion axially relative to the second portion in a first direction to place at least a portion of the at least one foot in the inner shoulder of the at least one flange, and to house the portion of the bucket handle in an axial bore defined by the channels of the first and second portions.

Further and other aspects of the invention will become apparent to one skilled in the art when considering the following detailed description of the preferred embodiments provided herein.

### BRIEF DESCRIPTION OF THE DRAWINGS

Drawings are included for the purpose of illustrating certain aspects of the invention. Such drawings and the description thereof are intended to facilitate understanding and should not be considered limiting of the invention. Drawings are included, in which:

FIGS. 1a, 1b, 1c, 1d and 1e are a top view, side view, bottom view, end view, and perspective view, respectively, of a first portion of a handle add-on according to one 1 embodiment of the present invention (collectively referred to herein as FIG. 1);

FIGS. 2a, 2b, 2c, 2d and 2e are a top view, side view, bottom view, end view, and perspective view, respectively, of a second portion of a handle add-on according to one embodiment of the present invention (collectively referred to herein as FIG. 2);

FIGS. 3a, 3b, and 3c show perspective views of the first and second portions in a respective sequence for connecting the two portions, according to an embodiment of the present invention; and FIG. 3d is a side view of FIG. 3c, wherein the handle add-on is in a closed position. FIGS. 3a to 3d are collectively referred to herein as FIG. 3.

FIG. 4a is a cross-sectional view of the handle add-on shown in FIG. 3d, along line A-A; FIG. 4b is a magnified view of FIG. 4a. FIGS. 4a and 4b are collectively referred to herein as FIG. 4.

FIGS. 5a and 5b are cross-sectional views of the handle add-on shown in FIG. 4a, along line B-B, in a closed position and an open position, respectively.

FIG. 6a is a cross-sectional view of the handle add-on in a closed position, shown with a handle positioned therein; FIG. 6b is a magnified view of a portion of FIG. 6a. FIGS. 6c and 6d are cross-sectional views of the handle add-on in FIG. 6a, along line P-P, shown with a large handle and a small handle, respectively. FIGS. 6a to 6d are collectively referred to herein as FIG. 6.

### DETAILED DESCRIPTION

The description that follows and the embodiments described therein are provided by way of illustration of an example, or examples, of particular embodiments of the principles of various aspects of the present invention. These examples are provided for the purposes of explanation, and not of limitation, of those principles and of the invention in its various aspects. In the description, similar parts are marked throughout the specification and the drawings with the same respective reference numerals. The drawings are not necessarily to scale and in some instances proportions may have been exaggerated in order more clearly to depict certain features.

The handle add-on of the present invention is a device for enhancing a conventional bucket handle and is intended for use with various types and sizes of buckets, including those commonly used in industries such as construction, restaurant, farming, painting, gardening, etc. The invention provides an ergonomic handle add-on for buckets that allows the weight of the bucket (and its contents) to distribute over a larger area of the user's fingers and/or hand, which may assist in relieving stress and discomfort on the user's fingers and/or hand and in reducing the risk of injury to the user's fingers and/or hand.

The handle add-on may be installed on the handles of various types and sizes of buckets including for example rubber mason pails and polyethylene buckets. The handle add-on may also be installed on any item with an arched or flat wire and/or rope bail.

The use of the handle add-on may reduce strain on joints, ligaments and muscles of the user's fingers, hand, wrist, forearm, elbow, shoulder, neck and/or back while the user carries heavy bucket loads. The handle add-on aims to provide proper hand ergonomics, which may assist the user to carry more weight more comfortably.

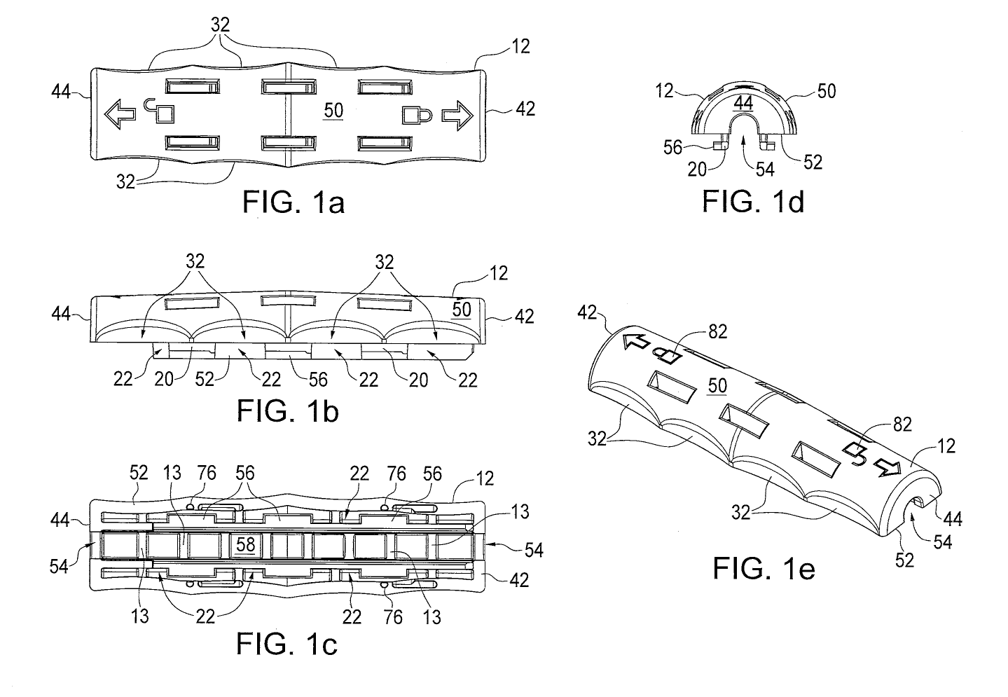

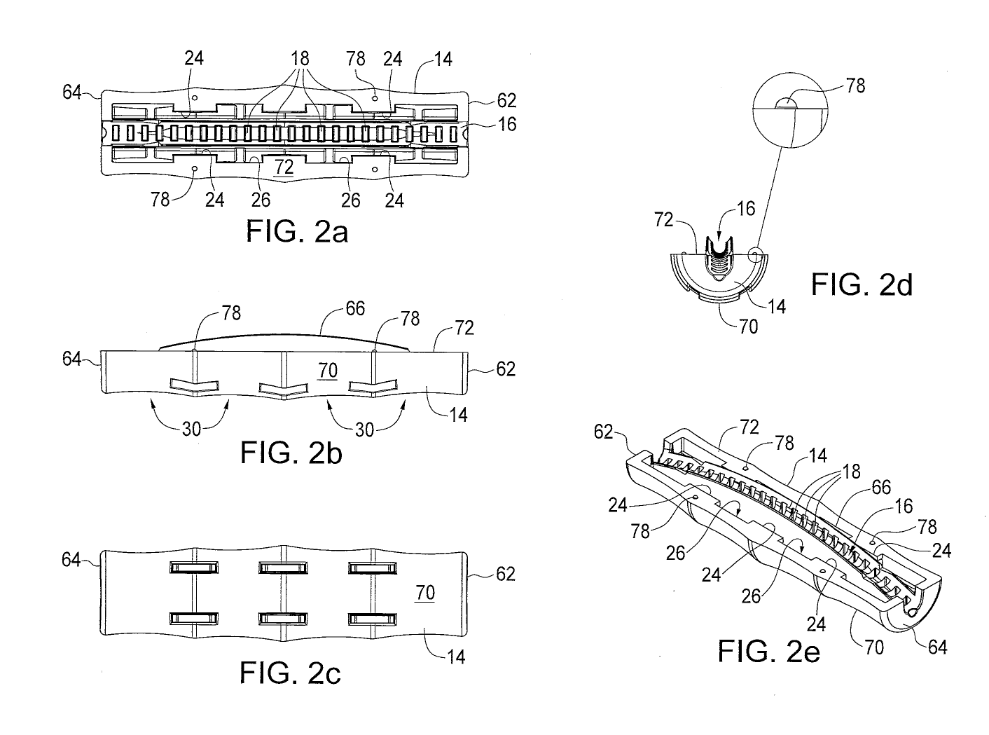

Referring to the FIGS. 1 and 2, the handle add-on of the present invention comprises a first portion 12 and a second portion 14. In one embodiment, the portions each have an elongated body, preferably having a shape that generally resembles a horizontal cylindrical segment, which has a generally semi-cylindrical outer surface (surface 50 for the first portion and surface 70 for the second portion) and a base (base 52 for the first portion and base 72 for the second portion).

The first and second portions are substantially symmetrical about their central long axis. As such, where only one lengthwise side of the handle add-on is described herein, the same description also applies to the other lengthwise side of the handle add-on. While each of the first and second portions is shown herein as substantially symmetrical about the central long axis, it is not necessary that the first and second portions be symmetrical.

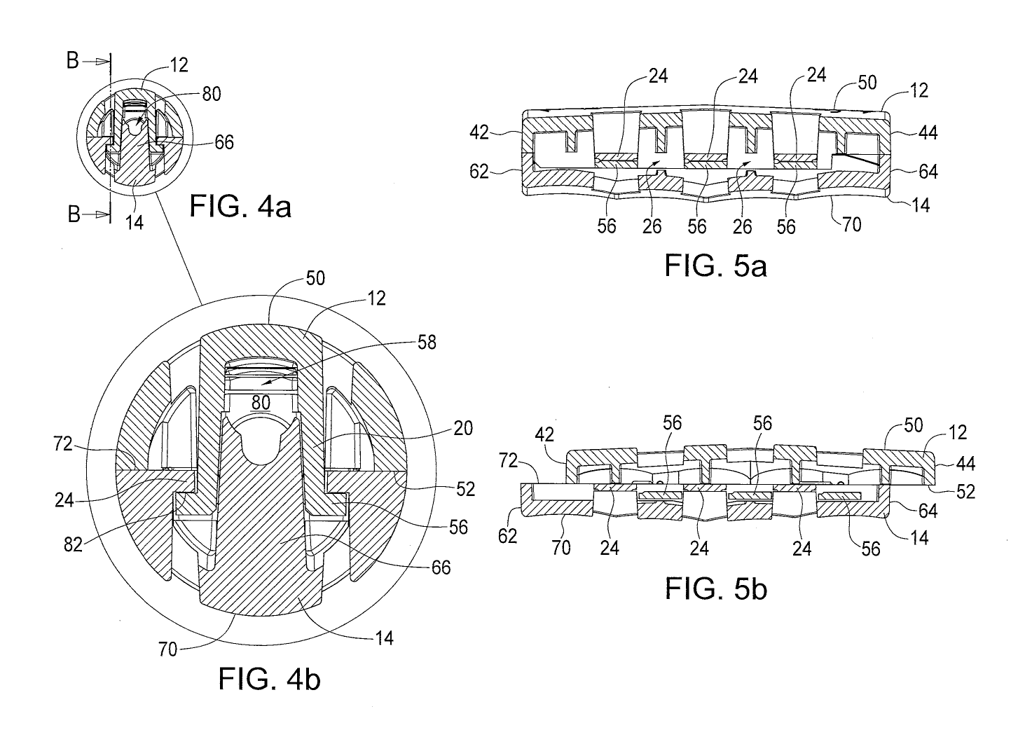

In a sample embodiment, as illustrated in FIGS. 1 and 4, the first portion 12 has a first end 42 and a second end 44 and includes a partially hollow interior configured to receive therein a portion of a handle (not shown) and to releasably engage the second portion by an axial sliding movement relative to the second portion, the details of which will be described hereinbelow.

The partially hollow interior of the first portion is configured to accommodate a portion of a handle and to provide space for axial movement of the handle relative to the first portion during installation and removal of the handle add-on. In one embodiment, the interior of the first portion includes a channel 58 extending between the ends 42, 44 of the first portion. In a further embodiment, the base of channel 58 includes protruding support ribs 13. The length of extension of each rib towards the base 52 may vary along the length of the channel 58. In a sample embodiment, the channel 58 may have a generally concave shape. For example, ribs 13 that are closer to ends 42, 44 have a longer extension than ribs that are near the middle of the interior of the first portion. In the illustrated embodiment, channel 58 is open at both ends 42, 44, at an opening 54 of each end.

As shown in FIGS. 2 to 4, the second portion 14 has a first end 62 and a second end 64 and includes a convexly arched channel 16 along its central long axis, between ends 62 and 64, for receiving and supporting a portion of a handle (not shown). In one embodiment, channel 16 is formed substantially along the central axis in an arched ridge 66, in between two peaks along the lengthwise sides at an upper portion of the ridge. Ridge 66 is sized and shaped to be matingly receivable in channel 58 of the first portion.

Channel 16 may include cooling holes 18 which are formed therein to help prevent deformation of the second portion 14 during the manufacturing process. In the illustrated embodiment, channel 16 is open at both ends 62, 64, at an opening 74 of each end. In one embodiment, the second portion is for receiving substantially all the load from the weight of the bucket (not shown) via the handle.

In the illustrated embodiment, with reference to FIGS. 1 to 5, the first and second portions are configured such that they are engageable and interlockable with one another by axial sliding movement relative to the other.

More specifically, along and/or near each lengthwise side of channel 58, the first portion includes at least one leg 20 that extends in the direction from the outer surface 50 to the base 52. Each leg 20 has at least one laterally extending foot 56 at or near its free end. In a preferred embodiment, the first portion includes a plurality of legs 20 intermittently positioned along and/or near each side of channel 58. Adjacent legs 20 are separated by a notch 22.

Alternatively, the first portion includes two legs 20, each forming a lengthwise side panel, which are positioned substantially parallel axially in the interior of the first portion to define channel 58. Each of the two legs has a plurality of feet 56, intermittently positioned along and/or near its free end. Adjacent feet 56 are separated by notch 22.

Along and/or near each lengthwise side in the interior of the second portion 14, there is least one flange 24 extending laterally in the direction from the outer surface 70 towards channel 16. An inner shoulder 82 is provided underneath each flange 24, for receiving and matingly engaging a foot 56 of the first portion, as described hereinbelow. In a preferred embodiment, the interior of second portion includes a plurality of flanges 24 intermittently positioned along and/or near each lengthwise side of the second portion. Adjacent flanges 24 are separated by a notch 26.

Notch 22 in the first portion is sized and shaped to allow a flange 24 to fit therethrough and notch 26 is sized and shaped to allow a foot 56 to fit therethrough, when the first portion is placed against the second portion, with bases 52 and 72 adjacent to and facing each other.

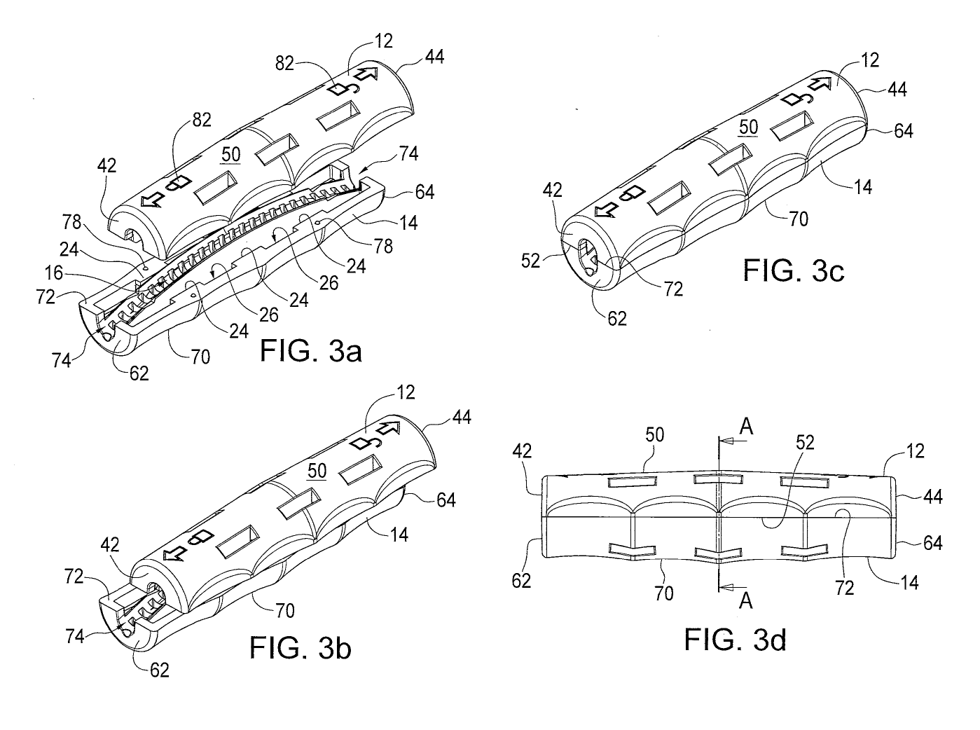

With reference to FIGS. 1 to 5, the spacing and alignment of the feet 56 and notches 26 are such that when feet 56 are aligned with notches 26 (i.e. when feet 56 are positioned to be receivable in notches 26), the first ends 42, 62 (and the second ends 44, 64) of the first and second portions are misaligned (for example, as shown in FIGS. 3b and 5b). Further, when feet 56 are aligned with notches 26, flanges 24 are aligned with notches 22.

When the first ends 42, 62 (and the second ends 44, 64) and the lengthwise sides of the first and second portions are substantially aligned and flush with one another, with bases 52 and 72 substantially parallel to and facing each other, feet 56 are misaligned with notches 26 (i.e. feet 56 cannot be received in notches 26) and there is at least some overlap between feet 56 and flanges 24 (for example, as shown in FIG. 5a). Preferably, when the first ends 42, 62 (and the second ends 44, 64) of the first and second portions are aligned and flush with one another, feet 56 and flanges 24 are almost perfectly aligned (for example, as shown in FIG. 5a).

In one embodiment, for example as shown in FIGS. 1 to 5, leg 20 extend beyond base 52 by an amount that allows foot 56 to be received in inner shoulder 82 underneath flange 24, when bases 52 and 72 are substantially parallel and are in contact with one another.

Further, when the first ends 42, 62 (and the second ends 44, 64) and the lengthwise sides of the first and second portions are substantially aligned and flush with one another, with bases 52 and 72 substantially parallel to and in contact with each other, an upper portion of ridge 66 is matingly received in channel 58 such that channel 16 and channel 58, together, define an axial bore 80 for accommodating a portion of a bail. In another embodiment, it is not necessary that ridge 66 be received in channel 58 to form axial bore 80. In other words, ridge 66 may be substantially outside channel 58 when bases 52 and 72 are in contact with each other.

In one embodiment, the handle add-on may include an ancillary locking mechanism, in addition to interlockable legs 20 and flanges 24. For example, the second portion may further include knobs 78 protruding from the surface of base 72, and the first portion 12 may further include indents 76 on the surface of base 52, for matingly receiving knobs 78. The positions of knobs 78 and indents 76 are such that each knob 78 is aligned with an indent 76 when bases 52 and 72 are substantially parallel to and facing each other and the first ends 42, 62 (and the second ends 44, 64) of the first and second portions are aligned and flush with one another. In an alternative embodiment, the first portion includes knobs while the second portion includes indents for receiving the knobs.

In a sample embodiment, the outer surface 50, 70 or a portion thereof of one or both of the portions may be shaped to accommodate the shape of the user's hands and/or fingers. For example, as shown in FIGS. 1 to 3, the outer surface 70 of the second portion 14 includes concave sections 30. Further, the lengthwise side edges at surface 50 of first portion 12 include concave areas 32.

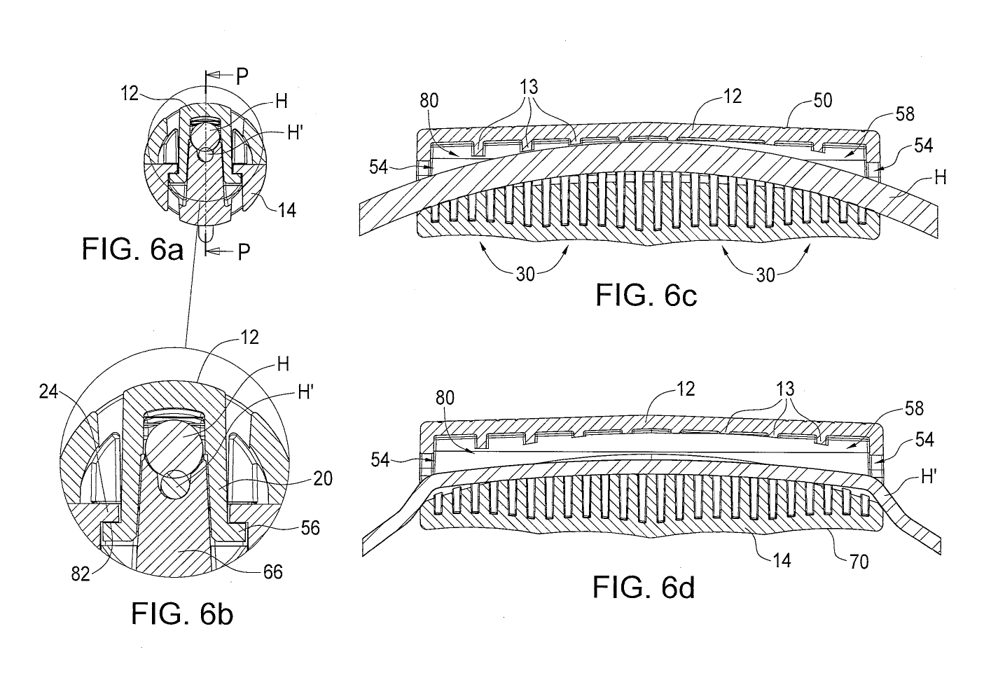

In a further embodiment, with reference to FIGS. 4 and 6, channel 16 is configured to accommodate handles having different diameters. In the illustrated embodiment, the peaks along the sides of ridge 66 are shaped to provide channel 16 with at least two different inner diameters. For example, when viewed from one end of the second portion, the peaks may be wider near the bottom of channel 16 and narrower near the top, thereby making the inner diameter of channel 16 smaller near the bottom. In the illustrated embodiment, with reference to FIG. 6, channel 16 is configured to receive therein bail H or bail H′, the diameter of latter is smaller than that of bail H. As such, the second portion 14 can be configured to accept bails of at least two different diameters in order to accommodate the common sizes of bails.

In one embodiment, the handle add-on is configured for installation on handles having a maximum diameter of about ¼″. Of course the handle add-on may be configured for installation on handles of other sizes.

In one embodiment, the first and second portions are made of polypropylene. However, the portions may be made of other suitable materials. The first and second portions of the handle add-on may be produced through an injection moulding process wherein each portion is individually moulded out of heated, liquid polypropylene and subsequently cooled to form the final product.

Optionally, the first portion may include indicia 82 for assisting a user to interconnect the first and second portions. For example, the indicia may comprise symbols, such as arrows, for indicating the directions of movement of the first portion relative to the second portion for placing the handle add-on in a closed position and an open position.

The first and second portions of the handle add-on are configured to be interlockingly engageable with one another. The handle add-on has at least two positions: an open position and a closed position. In the open position, the first and second portions are positioned relative to each other to be ready for transition into the closed position.

In the open position, the base 52 of the first portion 12 is positioned against the base 72 of the second portion 14, with the lengthwise sides of the first and second portions substantially aligned with one another, and with each foot 56 received in a notch 26 and each flange received in a notch 22. Due to the misalignment of feet 56 and flanges 24 in the open position, the first ends 42, 62 (and second ends 44, 64) of the portions are offset from one another, whereby a portion of base 72 is exposed at one end and a portion of base 52 is exposed at the other end of the handle add-on (for example, as shown in FIGS. 3b and 5b).

To transition the handle add-on to the closed position from the open position, the first portion is slid axially relative to the second portion, in the direction of the end of the handle add-on where a portion of base 72 is exposed (the “lock direction”). In a sample embodiment, once the first ends 42, 62 (and second ends 44, 64) of the portions are substantially aligned and flush with one another, the handle add-on is in the closed position (for example, as shown in FIGS. 3c, 3d, 4b, and 5a). In the closed position, each foot 56 is matingly engaged with at least a portion of a flange 24, by being at least partially received in the shoulder 82 of the flange, thereby interlocking the two portions together. Further, in the closed position, ridge 66 is matingly received in channel 58, thereby providing an axial bore 80 for housing a portion of a bail.

If knobs 78 and indents 76 are included, the knobs and indents are misaligned when the handle add-on is in the open position. As the handle add-on transitions from the open position into the closed position, each knob moves towards an indent. When the handle add-on reaches the closed position, the knobs are snapped into place into the indents. Once the knobs are in the indents, some axial force is required to displace the knobs from the indents, which may assist in securing the handle add-on in the closed position.

To transition handle add-on to the open position from the closed position, the first portion is shifted axially relative to the second portion, in a direction that is opposite of the lock direction (the “unlock direction”), until feet 56 are sufficiently aligned with notches 26 to be lifted out therethrough (and flanges 24 are sufficiently aligned with notches 22 to be removed therefrom), thereby allowing the first portion to be separated from the second portion. Some axial force is required to overcome the frictional engagement between the first and second portions, in order to move the first portion axially from the closed position.

If knobs 78 and indents 76 are included, an additional axial force will be required to displace the knobs from the indents in order to shift the first portion axially relative to the second portion. This requirement of an additional axial force to transition the handle add-on to the open position may help prevent the first and second portions from being uncoupled unintentionally during use.

As discussed above, indicia may be included to indicate the direction that the first portion is to be moved relative to the second position in order to transition from the open position to the closed position, and vice versa. For example, in the illustrated embodiment, outer surface 50 includes a lock symbol and an arrow pointing in the direction of end 42, and an unlock symbol and an arrow pointing in the direction of end 44, indicating that the first portion is to be moved in the direction of end 42 to transition to the closed position, and in the direction of end 44 to transition to the open position.

With reference to FIGS. 3, 4, and 6, a method for installing the handle add-on of the present invention to a bail is described herein. The method comprises: placing the second portion 14 on an underside of the bail such that a portion of the bail is received in the channel 16; positioning the first portion 12 over the second portion to place the handle add-on into the open position, as described above, wherein feet 56 are received in notches 26 (and flanges 24 are received in notches 22) and channel 58 covers most of the portion of the bail; and sliding the first portion axially relative to the second portion in the lock direction to transition the handle add-on into the closed position, as described above, wherein feet 56 are at least partially received in the shoulders 82 of flanges 24, the ends of the first portion are substantially flush with the corresponding ends of the second portion, and the portion of the bail is housed in bore 80 formed by channels 16 and 58.

A method for uninstalling the handle add-on from the bail comprises: sliding the first portion axially relative to the second portion in the unlock direction until the handle add-on reaches the open position, wherein feet 56 are aligned with notches 26 (and flanges 24 are aligned with notches 22) and are removable therefrom; separating the portions from one another; and removing the bail from the channel 16 of the second portion.

The handle add-on may be reinstalled on and then uninstalled from the same bail or a different one using the above described method.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A handle add-on for attachment to a bucket handle comprising:
a first portion having (i) an elongated body with a first end, a second end, two lengthwise sides, an outer surface and a base connecting the lengthwise sides, (ii) an axially extending channel in the elongated body that opens outwardly away from the base and opens at the first end and the second end, the channel having two lengthwise sides, (iii) at least one leg at or near each lengthwise side of the channel, the at least one leg extending in a direction from the outer surface to the base and having at least one foot extending laterally from a free end thereof, and (iv) a notch adjacent to the foot; and
a second portion having (i) an elongated body with a first end, a second end, two lengthwise sides, an outer surface and a base connecting the lengthwise sides, (ii) an axially extending ridge in the elongate body, the ridge having formed therein an axially extending convexly arched channel that opens outwardly away from the base and opens at the first end and the second end, (iii) at least one flange at or near each lengthwise side, extending laterally in a direction from the outer surface towards the arched channel, the at least one flange providing an inner shoulder thereunder for receiving and matingly engaging at least a portion of the at least one foot, and (iv) a notch adjacent to the flange for receiving the at least one foot therethrough,
the notch of the first portion for receiving the at least one flange therethrough,
the handle add-on having an open position, wherein the bases of the first and second portions are substantially parallel and in contact with one another, the at least one foot is received in the notch of the second portion, the at least one flange is received in the notch of the first portion, the channels of the first and second portions are substantially aligned, and the first portion and second portion are separable from one another; and
a closed position, wherein the bases of the first and second portions are substantially parallel and in contact with one another, at least a portion of the at least one foot is received in the inner shoulder of the at least one flange, thereby interlocking connecting the first and second portions, and the channels of the first and second portions defining an axial bore.

2. The handle add-on of claim 1 wherein the first portion is shifted axially relative to the second portion in a first direction to transition the handle add-on from the open position to the closed position, and the first portion is shifted axially relative to the second portion in a second direction, opposite the first direction, to transition the handle add-on from the closed position to the open position.

3. The handle add-on of claim 1 wherein the at least one foot is intermittently positioned along or near each lengthwise side of the channel in the first portion, and the notch of the first portion is in between adjacent feet.

4. The handle add-on of claim 1 wherein the at least one flange is intermittently positioned along or near each lengthwise side of the second portion, and the notch of the second portion is in between adjacent flanges.

5. The handle add-on of claim 1 wherein the first end of the first portion is offset from the first end of the second portion in the open position, and is flush with the first end of the second portion in the closed position.

6. The handle add-on of claim 1 further comprising an ancillary locking mechanism.

7. The handle add-on of claim 6 wherein the ancillary locking mechanism comprises at least one knob on the base of the second portion and at least one indent on the base of the first portion for receiving the at least one knob, or vice versa, and the at least one knob is received in the at least one indent when the handle add-on is in the closed position.

8. The handle add-on of claim 1 wherein the channel of the first portion has a generally concave shape.

9. The handle add-on of claim 1 wherein the outer surface of one or both of the first and second portions is generally semi-cylindrical.

10. The handle add-on of claim 1 wherein one or both of the outer surfaces of the first and second portions include concave sections or areas for accommodating a hand or fingers of a user.

11. The handle add-on of claim 1 wherein the channel of the second portion is configured to accept at least two different diameters of bucket handle.

12. The handle add-on of claim 1 wherein the first and second portions are made of polypropylene.

13. The handle add-on of claim 1 wherein the first or the second portion includes indicium to indicate a relative direction of movement of the first portion against the second portion for placing the handle add-on in the closed position from the open position.

14. A method of installing a handle add-on on to a bucket handle comprising:
placing an underside of a portion of the bucket handle in a channel of a second portion of the handle add-on, the handle add-on comprising a first portion having (i) an elongated body with a first end, a second end, two lengthwise sides, an outer surface and a base connecting the lengthwise sides, (ii) an axially extending channel in the elongated body that opens outwardly away from the base and opens at the first end and the second end, the channel having two lengthwise sides, (iii) at least one leg at or near each lengthwise side of the channel, the at least one leg extending in a direction from the outer surface to the base and having at least one foot extending laterally from a free end thereof, and (iv) a notch adjacent to the foot; and the second portion having (i) an elongated body with a first end, a second end, two lengthwise sides, an outer surface and a base connecting the lengthwise sides, (ii) an axially extending ridge in the elongate body, and the channel being formed in the ridge, the channel being convexly arched and axially extending in the ridge, and the channel opens outwardly away from the base and opens at the first end and the second end, (iii) at least one flange at or near each lengthwise side, extending laterally in a direction from the outer surface towards the arched channel, the at least one flange being receiving in the notch of the first portion and providing an inner shoulder thereunder for receiving and matingly engaging at least a portion of the at least one foot, and (iv) a notch adjacent to the flange for receiving the at least one foot therethrough;
positioning the first portion over the second portion to place the bases of the first and second portions substantially parallel and in contact with one another, the at least one foot in the notch of the second portion, and the at least one flange in the notch of the first portion, to align the channels of the first and second portions whereby most of the portion of the bucket handle is covered by the channel of the first portion; and
sliding the first portion axially relative to the second portion in a first direction to place at least a portion of the at least one foot in the inner shoulder of the at least one flange, and to house the portion of the bucket handle in an axial bore defined by the channels of the first and second portions.

15. The method of claim 15 further comprising uninstalling the handle add-on from the bucket handle by sliding the first portion axially relative to the second portion in a second direction opposite to the first direction, to align the at least one foot with the notch of the second portion, thereby removing the at least one foot from the inner shoulder; separating the first portion from the second portion; and removing the portion of the bucket handle from the channel of the second portion.

16. The method of claim 15 wherein the shape of one or both of the first and second portions resembles a horizontal cylindrical segment.

17. The method of claim 15 wherein one or both of the outer surfaces of the first and second portions include concave sections or areas for accommodating a hand or fingers of a user.

18. The method of claim 15 wherein the channel of the second portion is configured to accept at least two different diameters of bucket handle.

19. The method of claim 15 wherein the first or the second portion includes indicium to indicate the first direction.

20. The method of claim 16 wherein the first or the second portion includes indicium to indicate the second direction.
